(19) United States
(12) Patent Application Publication
(10) Pub. No.: US 2016/0077060 A1
(43) Pub. Date: Mar. 17, 2016

(54) PROCESS SAMPLE AND DILUTION SYSTEMS AND METHODS OF USING THE SAME

(71) Applicant: Waters Technologies Corporation, Milford, MA (US)

(72) Inventors: Sylvain Cormier, Mendon, MA (US); Aaron Phoebe, Uxbridge, MA (US); Charles Phoebe, Uxbridge, MA (US)

(73) Assignee: WATERS TECHNOLOGIES CORPORATION, Milford, MA (US)

(21) Appl. No.: 14/850,351

(22) Filed: Sep. 10, 2015

Related U.S. Application Data
(60) Provisional application No. 62/049,758, filed on Sep. 12, 2014.

(51) Int. Cl. G01N 30/06; G01N 1/14; B01D 15/12; G01N 30/20; F04B 53/10

(52) U.S. Cl. CPC G01N 30/06; G01N 30/20; F04B 53/10; B01D 15/12; G01N 1/14; G01N 2030/027

(57) ABSTRACT

Process sample and dilution systems automatically draw sample from a reactor or other source of sample and prepare drawn sample for subsequent injection to a chromatographic column or a detector. The process sample and dilution system has an external pump valve assembly in fluidic communication with a process sample manager. The external pump valve assembly includes an external sampling valve, an external process valve, external pump and a mixing tee. The external sampling valve can be configured to automatically acquire sample from a reactor or other source of sample. The external pump discharges wash from the external process valve whereby sample is discharged from the external sampling valve to the mixing tee for quenching and dilution and subsequent processing by the process sample manager.

### CROSS REFERENCE TO RELATED APPLICATIONS

This application claims the benefit of priority to the U.S. Provisional Application No. 62/049,758 filed Sep. 12, 2014 incorporated herein by reference.

### FIELD OF THE INVENTION

The present invention generally relates to chromatography systems, and in particular, to systems, methods and devices for dilution and mixing of chromatographic samples.

### BACKGROUND OF THE INVENTION

Various industries use liquid chromatography systems to evaluate process reactions or manufacturing process lines. For example, pharmaceutical manufacturers often use a liquid chromatography system to monitor their process line by taking samples at various times or at different points along the process line to ensure that a manufacturing batch is to specification. Samples may include complex mixtures of proteins, protein precursors, protein fragments, reaction products, and other compounds, to list but a few. Other manufacturers may use liquid chromatography systems to profile a certain biochemical reaction, taking samples from the same point in the process line over time as the reaction progresses.

However, acquiring samples for analysis can be manually intensive. An individual must typically draw the sample manually from a process line, carry it to the liquid chromatography system, and load it into the system for injection and analysis. Throughout this handling, care must be taken to label the sample properly and to ensure a well-documented chain of custody, or otherwise risk introducing uncertainty into the results. In addition, if the sample needs diluting before injection, the individual must first thoroughly wash the container within which the dilution occurs to avoid contamination with previous samples. Moreover, manually prepared sample dilutions are often wasteful and not cost effective.

### SUMMARY OF THE INVENTION

Systems and methods systems, methods and devices for dilution and mixing of chromatographic samples are provided herein. One aspect provides a process sample and dilution system configured to be in fluidic communication with a chromatographic column or detector. In exemplary embodiments, the system includes a process sample manager and an external pump valve assembly. The process sample manager includes an online sampling valve and is connected to the chromatographic column or detector. In an exemplary embodiment, the external pump valve assembly is connected to the process sample manager and includes an external sampling valve connected to a reactor or a reactor flow stream and configured to draw sample from the reactor or the reactor flow stream. The external pump valve assembly can also include an external process valve connected to an external pump and the external sampling valve. The external pump valve assembly can further include a mixing tee connected to the external sampling valve and the online sampling valve of the process sample manager. In exemplary embodiments, the external pump valve assembly can be in a spaced relationship to the process sample manager.

In exemplary embodiments, the process sample and dilution system can include a wash source, where the wash source is configured to be in fluidic communication with the external pump and the external sampling valve. For example, the external pump can be configured to draw wash from a wash source into the external process valve and to discharge drawn wash from the external process valve to the external sampling valve.

In some embodiments, the process sample manager can include a process valve connected to a first diluent source and a process pump configured to be in fluidic communication with the mixing tee. For example, the process pump can be configured to draw diluent from a first diluent source and discharge diluent to the mixing tee.

In exemplary embodiments, the process sample manager can also include an injection needle and a fluidic tee. For example, the injection needle can be connected to the online sampling valve, and the fluidic tee can be configured to be in fluidic communication with the online sampling valve and a second diluent source. In some embodiments, the process sample manager can also include an injection valve configured to be in fluidic communication with the column or the detector and connected to the fluidic tee.

Another aspect provides an external pump valve assembly configured to be in fluidic communication with a solvent delivery system. In exemplary embodiments, the external pump valve assembly includes an external sampling valve, an external process valve connected to the external sampling valve, an external pump, and a mixing tee connected to the external sampling valve and the process sample manager. The external sampling valve can be connected to a reactor or a reactor flow stream and configured to draw sample from the reactor or the reactor flow stream. For example, the external sampling valve can be configured to acquire a discrete or continuous sample from a reactor or a reactor flow stream. In exemplary embodiments, to the external pump valve assembly can be connected to a process sample manager and the process sample manager can be configured to be in fluidic communication with the reactor or reactor flow stream and the solvent delivery system

In some embodiments, the external pump valve assembly can include a wash source, where the wash source is in fluidic communication with the external pump. For example, the external pump can be a positive displacement pump configured to draw wash from the wash source and discharge wash to the external sampling valve. In some embodiments, the mixing tee can be configured to be in fluidic communication with a first source of diluent.

An further aspect provides a liquid chromatography system that can include a column. In exemplary embodiments, the system includes an external pump valve assembly including an external sampling valve, an external pump and a mixing tee. The external sampling valve can be connected to a reactor or a reactor flow stream and can be configured to draw sample from the reactor or the reactor flow stream. The external process valve can be connected to the external sampling valve and the external pump and the mixing tee can be connected to the external sampling valve. The system further includes a process sample manager in fluidic communication with the external pump valve assembly and a solvent delivery system in fluidic communication with the process sample manager.

In exemplary embodiments, the system can include a wash source, where the wash source is configured to be in fluidic communication with the external pump and the external sampling valve. For example, the external pump can be configured to draw wash from a wash source into the external process valve and to discharge drawn wash from the external process valve to the external sampling valve. In some embodiments, the process sample manager can also include a process valve connected to a first diluent source and a process pump, where the process pump is configured to be in fluidic communication with the first diluent source and the mixing tee. For example, the process pump can be configured to draw diluent from the first diluent source and discharge or push diluent to the mixing tee.

Another aspect provides a method of sampling and diluting of a sample from a reactor or reactor stream for liquid chromatography detection. In exemplary embodiments, the method includes acquiring a discrete or continuous sample from a reactor or a reactor flow stream with an external pump valve assembly in fluidic communication with the reactor or the reactor flow stream where the external pump valve assembly includes an external pump, an external sampling valve, and a mixing tee, and each of the external pump, the external sampling valve and the mixing tee are configured to be in fluidic communication with the other. The method also includes one or both of quenching and diluting the sample in the mixing tee and discharging the sample to a process sample manager configured to be in fluidic communication with the external pump valve assembly and injecting the sample into a solvent composition stream received by a detector. In some embodiments, the process sample manager can be in a spaced relationship with the external pump valve assembly.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a block diagram showing a liquid chromatography system utilizing the process sample and dilution system presented herein.

FIG. 2 depicts the process sample and dilution system configured to calibrate system with calibration solution drawn from vial.

FIG. 3 shows the process sample and dilution system configured to move diluent from the first diluent source to the process valve.

FIG. 4 shows the process sample and dilution system configured to move diluted sample to the online sampling valve.

FIG. 5 shows the process sample and dilution system configured to fill the needle with diluted sample.

FIG. 6 shows the process sample and dilution system configured to further dilute sample.

FIG. 7 shows the process sample and dilution system configured to load sample into sample loop of the injection valve.

FIG. 8 shows the process sample and dilution system configured to inject sample into the solvent composition stream.

FIG. 9 shows the process sample and dilution system configured to wash fill.

FIG. 10 shows the process sample and dilution system configured to empty the wash fill.

FIG. 11 shows the process sample and dilution system ready for the next injection.

### DETAILED DESCRIPTION

As used herein, “online” means that the sample manager is connected directly to a process (or production) line to acquire samples from the process line in approximately real time without manual intervention. The sample manager can then dilute, load, and inject the acquired process samples for subsequent chromatographic analysis. The chromatographic analysis thus occurs in parallel to the continued operation of the process line. No distinction is made here between a production line and a process line.

As used herein, “at-line” means that the system is physically near but unconnected to the process line. In such systems, an individual acquires a process sample manually, carries and places the process sample into the system for processing.

As used herein, “in-line” means a system that is physically incorporated within the process line (i.e., the chromatographic analysis and process line operations in this instance are akin to serial processing).

Advantageously, the online system described herein does not require a separate container within which to perform the dilution. Rather, the dilution occurs within the plumbing (i.e., tubing and other internal components) of the sample manager by merging the acquired process sample with a diluent stream. Hence, a separate container is not washed to avoid contamination with a previously acquired and diluted sample. As another advantage, the online systems disclosed herein use smaller amounts of sample than is typically possible for dilutions executed within a container.

In addition, the process sample and dilution systems described herein can reduce the amount of sample consumed by a process sample manager and allow for connections to smaller reactors and other vessels less disturbing to the process.

The disclosed process sample and dilution systems allow a process sample manager to sample from concentrated reactions and can provide large dilution ranges. Preferably, sample dilution ranges from about 1 to 99 units of diluent to 1 unit of sample. However, the dilution range of a sample can extend to 5000 to 1, depending on the accuracy of the pump. The process sample and dilution systems can also permit quenching of the sample if needed. Furthermore, the systems can be configured such that undiluted sample is prevented from contacting pumps, which increases pump life by avoiding harsh chemicals that may be present in the undiluted sample.

Generally, a process sample manager is useful in both manufacturing and research environments. Process sample managers automatically manage sample aspiration and injection, collection and fraction analysis on a single platform and can be designed for use with HPLC or LC/MS systems. As described herein, an external pump valve assembly directly connects to a reactor or a process line to acquire a sample automatically in real time without manual intervention. However, the external pump valve assembly can also work with human intervention, manually. Furthermore, because the external pump valve assembly and/or the process sample manager can work off-line as well, the sample can be quenched, diluted and/or injected into chromatography equipment for subsequent analysis on demand. Multiple analyses can also occur in parallel and during operation of the process sample manager.

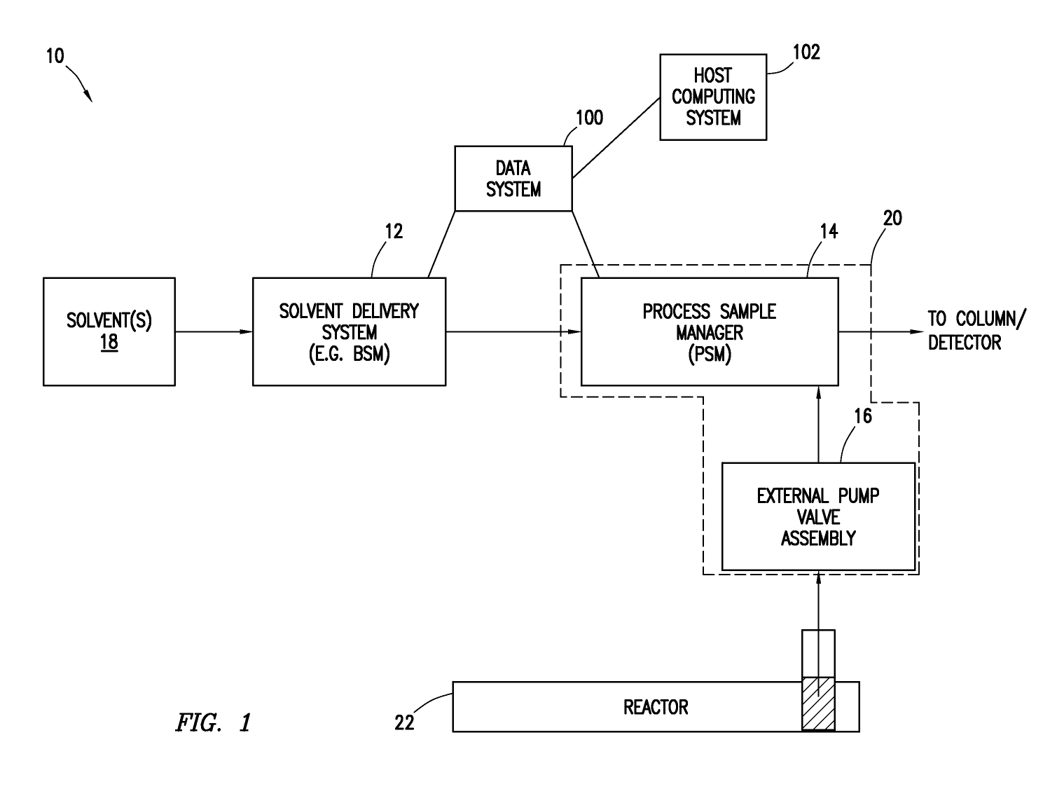

FIG. 1 is a block diagram of a liquid chromatography system 10 for separating a mixture into its constituents as provided herein. The liquid chromatography system 10 includes a process sample and dilution system 20 and a solvent delivery system 12. The process sample and dilution system 20 is in fluidic communication with a reactor 22 or a reactor flow stream (not shown). The process sample and dilution system 20 is also in fluidic communication with a solvent delivery system 12. The solvent delivery system 12 provides a solvent composition stream to the process sample and dilution system 20 via the process sample manager 14. Subsequently, the solvent composition stream is combined with diluted sample and sent to, and received by, a chromatographic column or detector (not shown). The process sample and dilution system 20 comprises a process sample manager 14 and an external pump valve assembly 16. The external pump valve assembly 16 of the process sample and dilution system 20 is directly connected to the reactor 22 or other vessel or reactor flow stream or other process line by tubing. The process sample and dilution system 20 can automatically or manually acquire samples from the reactor 22 or the reactor flow stream (not shown).

The external pump valve assembly 16 can acquire a sample from a point on a process flow stream, a reactor flow stream or directly from the reactor. The external pump valve assembly can acquire samples at different stages (location and/or time-based) of the manufacturing process. For example, the external pump valve assembly 16 can acquire samples from the reactor 22 or reactor flow stream at different time intervals in order to monitor the progress of a chemical reaction. Furthermore, the external pump valve assembly 16 can acquire samples continuously or at different stages (location and/or time-based). In general, the reactor 22 or other vessel and/or the reactor flow stream or other process lines are representative of various process sources including manufacturing processes, beaker reactions, exit line (cleaning validation), reaction chamber and fermentation reactions.

Importantly, the external pump valve assembly 16 allows the process sample manager 14 to monitor any process or reaction which may be located a substantial distance from the process sample manager 14, or, alternatively, in close proximity to the process sample manager 14. As such, the term “remote” as used herein simply means separate (i.e., a separate module) or detached and simply set apart in a spaced relationship where a spaced relationship means as close together as possible or as far apart as necessary. The term remote is not intended to mean that the external pump valve assembly 16 is isolated from or otherwise positioned or located a significant distance away from process sample manager 14 and/or the reactor or reactor flow stream. The devices and methods described herein may include those situations where the external pump valve assembly 16 is close or positioned next to or even within the process sample manager 14. On the other hand, the external pump assembly 16 and the process sample manager 14 may be a substantial distance away from each other. In addition, more than one external pump valve assembly 16 (a plurality) may be used to delivery samples to a single process sample manager 14.

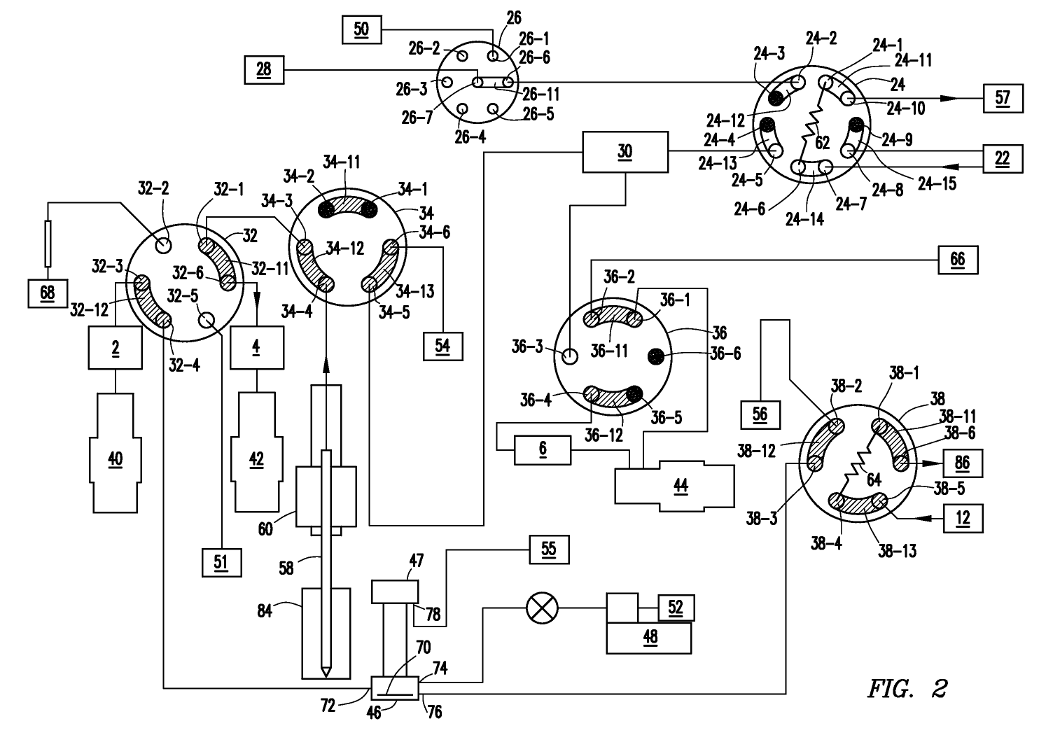

As shown in FIG. 2, the process sample manager 14 is in fluidic communication with the external pump valve assembly 16 which is in fluidic communication with a reactor 22 or reactor flow stream. The external pump valve assembly 16 is also in fluidic communication with the process sample manager 14. In addition, the external pump valve assembly 16 is in fluidic communication with a first diluent source 66. The process sample manager 14 is in fluidic communication with a first diluent source 66 and the solvent delivery system 12. Moreover, the process sample manager 14 is in fluidic communication with a chromatographic column 86 of particulate matter, or a detector such as a mass spectrometer, for receiving an elution comprised of a diluted process sample combined with the solvent composition stream provided by the solvent delivery system 12. Also, useful in connection with the subject devices and methods is a mass spectrometer.

The solvent delivery system 12 can include a low-pressure gradient pumping system (not shown) in fluidic communication with reservoirs from which the pumping system draws liquid solvents through tubing. In a low-pressure gradient pumping system (not shown), mixing of solvents typically occurs before the pump. The solvent delivery system 12 also may have a mixer in fluidic communication with the solvent reservoirs to receive various solvents in metered proportions. This mixing of solvents occurs in accordance with an intake profile, and produces a solvent (mobile phase) composition that remains unchanged (isocratic) or varies over time (gradient). Hence, the pumping system of a solvent delivery system 12 is in fluidic communication with a mixer (not shown) and can draw a continuous flow of solvent mixture therefrom for delivery to an autosampler. To draw and deliver the solvent mixture, the pumping system (not shown) can provide a flow rate in the range of 0.010 ml/min to 2 ml/min at 15,000 psi. Examples of solvent delivery systems that can be used to implement the pumping system include, but are not limited to, the ACQUITY HPLC Binary Solvent Manager, manufactured by Waters Corp. of Milford, Mass. See, e.g., US 2012/0303167 at ¶[0019].

Hence, by way of example, the solvent delivery system 12 can be a binary solvent manager (“BSM”), which uses two individual serial flow pumps to draw solvents from reservoirs (not shown) and deliver the solvent composition to the process sample manager 14. Here, each of the BSM's two independent pumps (not shown) contains two linear-drive actuators (not shown). Each actuator pair has a single reciprocating serial pump (not shown) that delivers precise flow of a single solvent. The two pump systems (not shown) combine their two solvents at a filter/tee mixer (not shown). From there, the solvent mixture flows into the process sample manager 14. A gradient elution program is commonly used so that the eluent composition (and strength) is steadily changed during the analysis. This increases separation efficiency, decreases the retention time and improves peak shape by minimizing tailing. See, e.g., T Jiang Y, Vaidya L, The Waters ACQUITY® Ultra-Performance Liquid Chromatograph and the Micromass Quattro Premier Triple Quadrupole Mass Spectrometer, December, 2012.

The liquid chromatography system 10 may also include a data system 100 that is in signal communication with the process sample and dilution system 20 and the solvent delivery system 12. The data system 100 has a processor (not shown) and a switch (not shown), e.g., an Ethernet switch for handling signal communication between the solvent delivery system 12 and the process sample and dilution system 20. In addition, the data system 100 is programmed to implement the various phases of operation performed by the process sample and dilution system 20 (e.g., turning pumps on and off, rotating valves) in order to automatically acquire and dilute a process sample and introduce the diluted process sample to the solvent composition stream, as described herein. In addition, a host computing system 102 is in communication with the data system 100, by which personnel can download various parameters and profiles to affect the data system's performance.

As shown in the figures, the process sample and dilution system 20 comprises the external pump valve assembly 16 and a process sample manager 14 sometimes referred to herein as “PSM.” The external pump valve assembly 16 includes an external sampling valve 24, an external process valve 26, a mixing tee 30 and an external pump 28. The process system manager 14 has a priming valve 32, an online sampling valve 34, a process valve 36 and an injection valve 38.

Each of the valves is a separate, independently operable rotary valve having a plurality of fluidic ports and one or more flow-through conduits. Although described primarily as rotary valves, any one or more of these valves: priming, sampling, selection, and/or injection, can be another type of valve including, but not limited to, slider valves, solenoids, and pin valves. Each flow-through conduit provides a pathway between a pair of neighboring fluidic ports. When a given valve rotates, its flow-through conduits move clockwise or counterclockwise, depending upon the valve's direction of rotation. This movement operates to switch the flow-through conduit to a different pair of neighboring fluidic ports, establishing a fluidic pathway between that different pair while removing the pathway from the previously connected pair of fluidic ports.

Further, the valves are sometimes described herein with respect to a particular configuration and rotation thereof, especially as it may relate to the processing of sample within external pump valve assembly 16 and the process sample manager 14. However, the valves, including the external sampling valve 24 the priming valve 32, the online sampling valve 34, the process valve 36, and the injection valve 38, could each rotate in an opposite direction from that which is described herein and shown in the figures (i.e., clockwise as opposed to counterclockwise or counterclockwise as opposed to clockwise) and still accommodate the same functionality and overall workings of the process sample and dilution system 20 provided herein. In short, the valves and the operation of the valves are not limited to the manner of rotation or a specific configuration described herein. Likewise the configuration of the external process valve is not limited to the fluidic pathways or connections between specific fluidic ports and flow-through conduit described herein.

In addition, unless otherwise specified, all connections are fluidic and provide for fluid flow, including but not limited to, tubing connections between fluidic ports and devices such as the reactor, the reactor flow stream, valves, pumps and other apparatus such as injection needles, tees, and reservoirs that are described herein. Such connections are typically made via tubing ranging in size from 0.005 to 0.150 inches and made of stainless steel, PEEK, Telfon, and/or any material suitable for the pressure and composition of the sample. Also, flow-through conduits are fluidical connections where the ports and conduits are fluidically connected to each other and/or other devices described. Hence, when it is stated that a device, fluidic port or flow-through conduit is connected or in fluidic communication with the other, this means and should be understood to mean that such connection is fluidic unless otherwise noted.

As shown in the figures, the process sample and dilution system 20 comprises the process sample manager 14 and the external pump valve assembly 16. As noted above, the external pump valve assembly 16 comprises the external sampling valve 24, the external process valve 26, the mixing tee 30 and the external pump 28. The process sample manager 14 comprises the priming valve 32, the online sampling valve 34, the process valve 36, and the injection valve 38. The process sample manager 14 further includes a diluent pump 40, a sample pump 42, an injection needle 58 and a fluidic tee 46.

In an exemplary embodiment, the external sampling valve 24 has ten fluidic ports 24-1, 24-2, 24-3, 24-4, 24-5, 24-6, 24-7, 24-8, 24-9, and 24-10 and five flow-through conduits 24-11, 24-12, 24-13, 24-14, and 24-15. Fluidic ports 24-3, 24-4 and 24-9 are plugged and not utilized. A first sample loop 62 connects fluidic ports 24-1 and 24-6. Tubing connects fluidic port 24-2 to fluidic port 26-6 of the external process valve 26. Tubing connects fluidic port 24-5 to the mixing tee 30. Tubing connects fluidic port 24-7 to the reactor 22. Further, tubing connects fluidic port 24-8 to the reactor 22. Tubing connects the fluidic port 24-5 to the mixing tee 30. Tubing connects fluidic port 24-10 to a fourth waste reservoir 57. As shown in the figures, sample enters the external sampling valve 24 and is cycled to the fourth waste reservoir 57. If recycling of the sample drawn from the reactor 22 is desired, additional steps and/or equipment is typically required once the sample is contained in the fourth waste reservoir 57 to ensure that the sample is not contaminated. Sample constantly flows through the first sample loop 62 when not sampling. In the idle configuration, the external pump 28 is off and not running Likewise pumps 40, 42, 44 and 48 are off. Indeed, the external pump 28 is on only during dilution process for a short period.

As shown in the figures, the external process valve 26 has seven fluidic ports 26-1, 26-2, 26-3, 26-4, 26-5, 26-6 and 26-7 and one flow-through conduit 26-11. Tubing connects the fluidic port 26-1 to a first wash reservoir 50. Tubing further connects fluidic port 26-6 of the external sampling valve 24. Tubing also connects fluidic port 26-7 of the external process valve 26 to the external pump 28. As described herein, flow-through conduit 26-11 connects fluidic port 26-6 to fluidic port 26-7 or connects fluidic port 26-1 to fluidic port 26-7.

In exemplary embodiments, the external pump 28 is a positive displacement pump. During startup, a liquid positive displacement pump cannot simply draw air until the feed line and pump fill with the liquid that requires pumping. Typically, an operator must introduce liquid into the system to initiate the pumping. While loss of prime is usually due to ingestion of air into the pump, the clearances and displacement ratios in pumps for liquids and other more viscous fluids usually cannot displace air due to its lower density. In the present assembly, however, the external process valve 26 replaces the need for manually introducing liquid into the external pump 28 because the external process valve 26 performs this function.

With regards to the process sample manager, the priming valve 32 has, in exemplary embodiments, six fluidic ports 32-1, 32-2, 32-3, 32-4, 32-5 and 32-6 and two flow-through conduits 32-11 and 32-12. Tubing connects fluidic port 32-1 to fluidic port 34-3 of the online sampling valve 34. Likewise, tubing connects fluidic port 32-2 to a second diluent source 68. Further, tubing connects fluidic port 32-3 to a diluent pump 40. Tubing connects fluidic port 32-4 to a fluidic tee 46. Fluidic port 32-5 is connected to a second wash reservoir 51. Tubing connects fluidic port 32-6 to a sample pump 42. The two flow-through conduits 32-11 and 32-12 can move clockwise and back for diluent to flow into the fluidic tee 46 and to discharge (push) sample to the injection needle 58.

In exemplary embodiments, the process sample and dilution system 20 also includes the fluidic tee 46 having a seat 70 to inject process sample into the fluidic tee 46 and a first inlet 72 to receive diluent from the priming valve 32. The fluidic tee 46 has a first outlet 76 connected to the injection valve 38. The fluidic tee 46 also has a second inlet 74 connected to a wash pump 48. During a wash cycle further described below, the wash pump 48 receives wash from a third wash reservoir 52 and pumps wash to the fluidic tee 46 through a second outlet 78 fluidically connected to a second waste reservoir 55. The use of fluidic tees is further described in U.S. Pat. No. 7,754,075 issued Jul. 13, 2010 at Col. 5, 1. 8 to Col. 8, 1. 18, incorporated herein by reference.

In operation, the tip of an injection needle 58 moves in and out of the seat 70 of the fluidic tee 46 under the control of a needle drive 60. The seat 70 produces a leak-proof seal when the tip of the injection needle 58 enters the fluidic tee 46. In addition to controlling the movement and position of the injection needle 58 into and out of the seat 70 of the fluidic tee 46, the needle drive 60 can also move the injection needle 58 in an angular direction.

In exemplary embodiments, the online sampling valve 34 has six fluidic ports 34-1, 34-2, 34-3, 34-4, 34-5, and 34-6 and three flow-through conduits 34-11, 34-12, and 34-13. Fluidic ports 34-1 and 34-2 are plugged. Tubing connects fluidic port 34-3 to fluidic port 32-1 of the priming valve 32. Tubing connects fluidic port 34-4 to the injection needle 58. In addition, the mixing tee 30 is connected by tubing to fluidic port 34-5 of the online sampling valve 34. In the system idle configuration and as shown in FIG. 2, flow-through conduit 34-13 provides a fluidic pathway between fluidic ports 34-5 and 34-6, thereby providing a continuous fluidic pathway between the mixing tee 30 and the first waste reservoir 54.

Similarly, as shown in the exemplary embodiments of the figures, the process valve 36 has six fluidic ports 36-1, 36-2, 36-3, 36-4, 36-5 and 36-6 and two flow-through conduits 36-11 and 36-12. Fluidic ports 36-5 and 36-6 are plugged. Tubing connects fluidic port 36-1 to the process pump 44. Further, tubing connects fluidic port 36-2 to a first diluent source 66. Also, tubing connects the mixing tee 30 to fluidic port 36-3 of the process valve 36.

Further shown in the exemplary embodiments of the figures, an injection valve 38 has six fluidic ports 38-1, 38-2, 38-3, 38-4, 38-5 and 38-6, three flow-through conduits 38-11, 38-12 and 38-13, and a second sample loop 64. The second sample loop 64 is connected to the fluidic ports 38-4 and 38-1. Tubing connects fluidic port 38-2 to a third waste reservoir 56. Tubing connects fluidic port 38-3 to the fluidic tee 46. Further, tubing connects the solvent delivery system 12 to fluidic port 38-5. Also, tubing connects fluidic port 38-6 to the column 86. When the system is idle, flow-through conduit 38-11 provides a fluidic pathway between fluidic ports 38-1 and 38-6. Likewise, flow-through conduit 38-12 provides a fluidic pathway between fluidic ports 38-2 and 38-3 and flow-through conduit 38-13 provides a fluidic pathway between fluidic ports 38-4 and 38-5. The solvent delivery system 12 is on in order to maintain minimal disturbance to the solvent composition stream. Hence, the solvent composition stream continuously flows. In the idle position, the solvent composition stream flows into fluidic port 38-5 through flow-through conduit 38-13 out fluidic port 38-4 through the second sample loop 64 into fluidic port 38-1 through flow-through conduit 38-11 and out fluidic port 38-6 to the column 86. The PSM allows injections of 1, 2, and 5 μl. On the other hand, the injection valve 38 has the capacity to handle larger volumes. However, this would require a larger volume of process sample. Also, the transducers are active and allow the PSM to monitor the pressure during the dilution and/or quenching of the sample to ensure that the sampling, dilution, quenching and injection were performed properly.

The process sample and dilution system 20 can be used to monitor any process or reaction where the reactor or the reactor flow stream is near or far away from the PSM. The maximum distance between the reactor or reactor flow stream and the process sample and dilution system 20 is related to the pressure of the pressurized reactor 22 or reactor stream.

The maximum distance between the reactor 22 or reactor flow stream (not stream) and the process sample and dilution system 20, i.e., the length of tubing between those two systems, can be mathematical represented as follows: Δp=8*ρ*(V²)/(π²*D⁴)*λ*L/D*0.00014504, where
ρ=solvent density (kg/m³)
V=flow velocity (m³/s)
D=tube diameter (m)
λ=Coefficient of friction
L=length of tube
0.00014504=Pa to psi.

Sample volume must be large enough to be transferred from the reactor 22 to the injection valve 38. In the present system 20, sample flow is largely undisturbed and unaffected by the system 20. If sample is first diluted, a larger volume is created and sample can be transferred farther. Because tubing diameters are narrow, sample diffusion is minimized regardless of distance transferred. In the present systems, samples largely remain intact because contact area between sample and solvent is minimized. Diffusion of any sample at the edges of the tubing, however, can go to waste and is not part of a representative sample. With the use of a backwash in the system 20, dispersion of the sample is avoided. In addition, the amount of sample required for the column 86 or the detector (not shown) is minimized because of the low rate of dispersion of sample into the wash.

The process sample can be drawn from the reactor 22 or reactor stream operating under pressure or for a non-pressurized reaction where the reactor 22 or other vessel is not operating under pressure (greater than about 1 atmosphere or 14.7 psi at sea level). The process sample and dilution system 20 described herein dilutes a sample drawn from the reactor by diluting sample at the mixing tee 30 (also sometimes referred to as direct dilution line load) and optionally, further dilutes the sample at the fluidic tee 46 of the process sample manager 14. Furthermore, the system 20 can provide a direct sample load to the injection valve 38 without sample dilution.

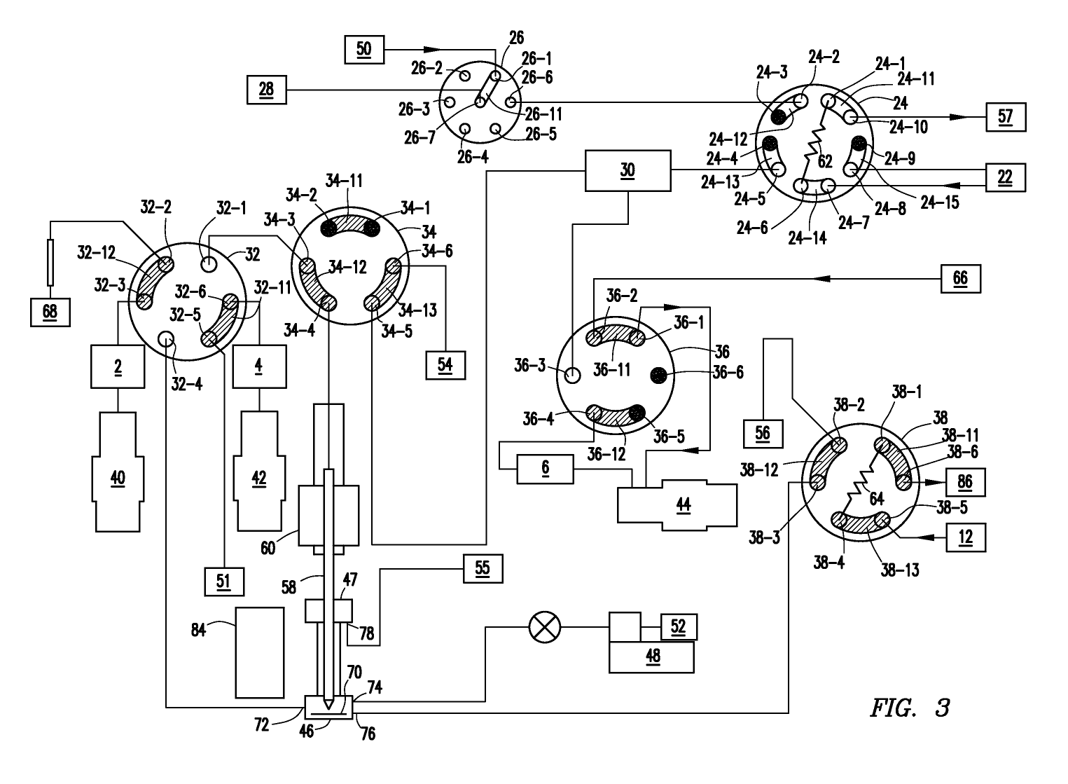

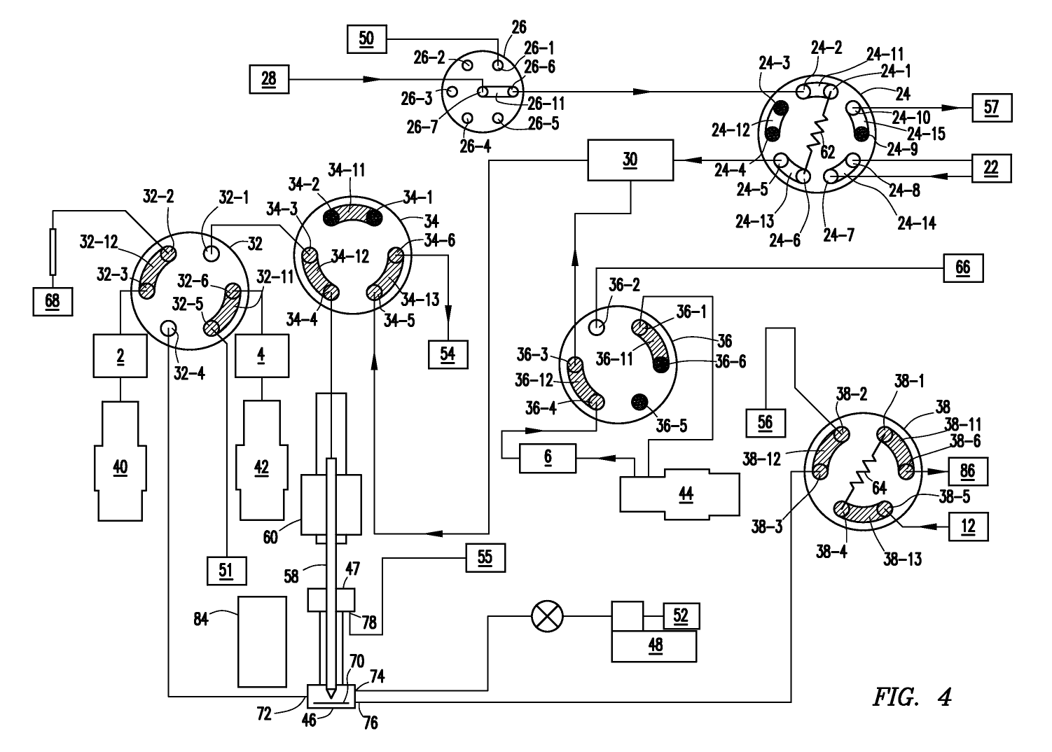

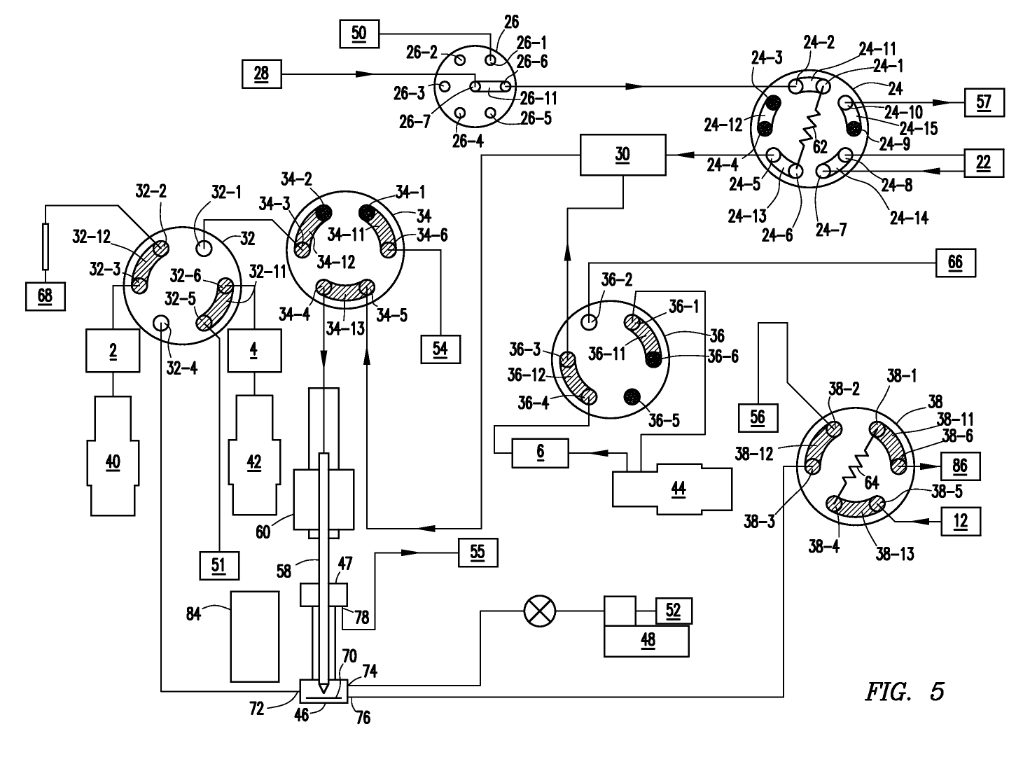

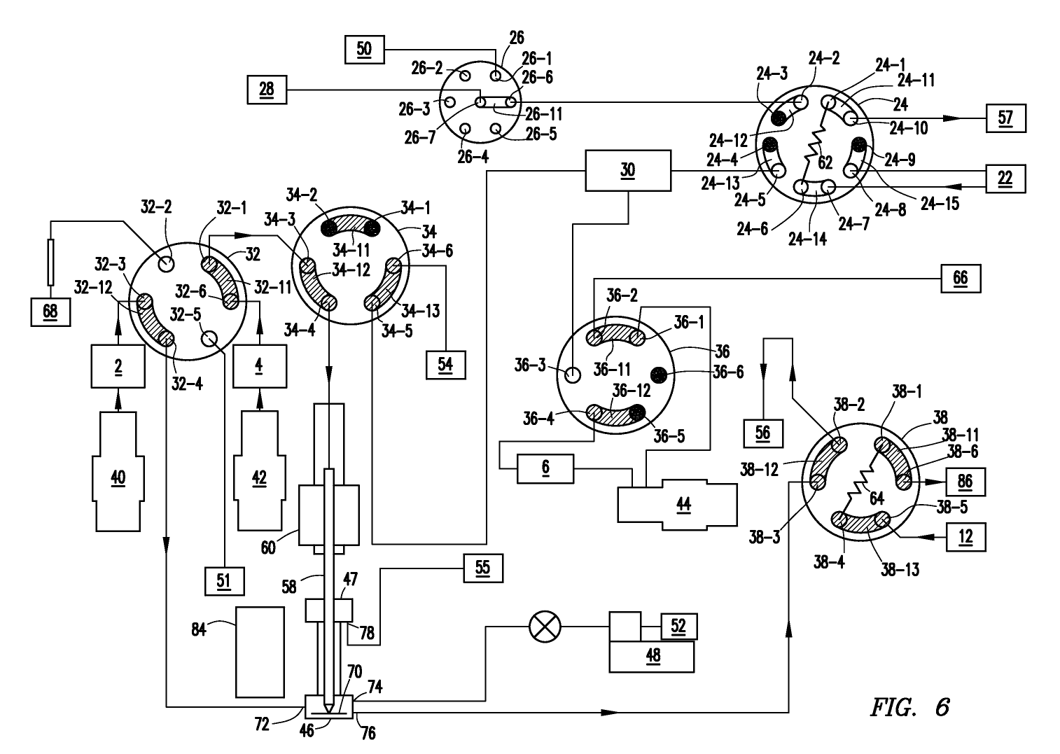

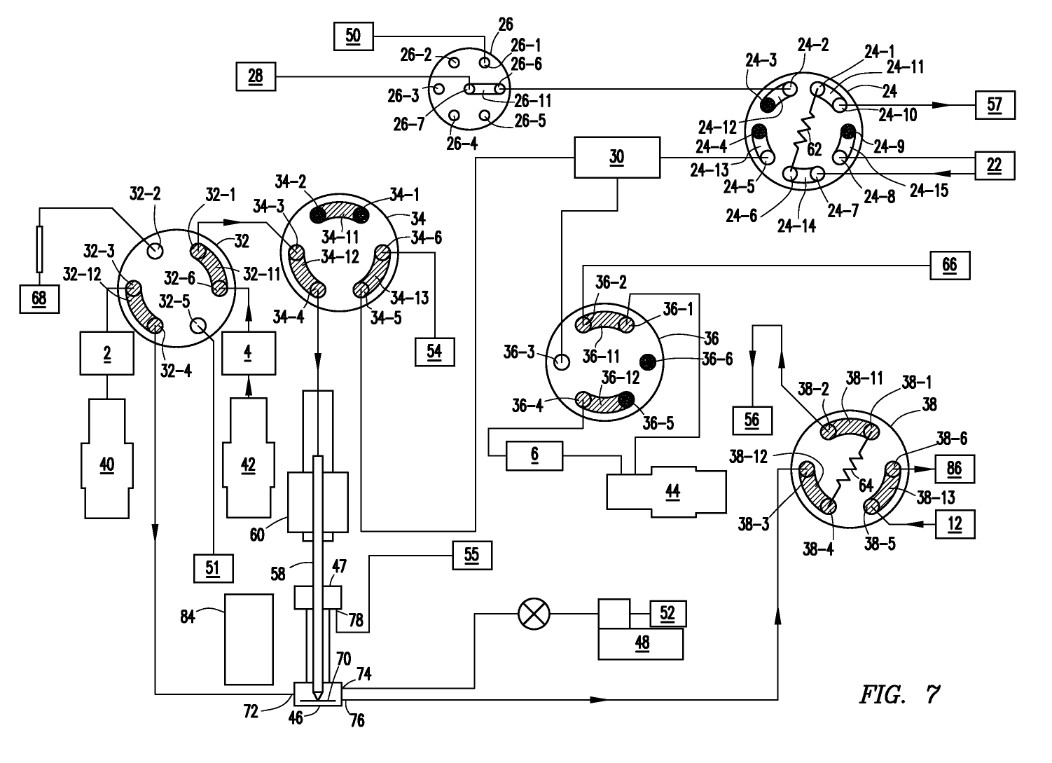

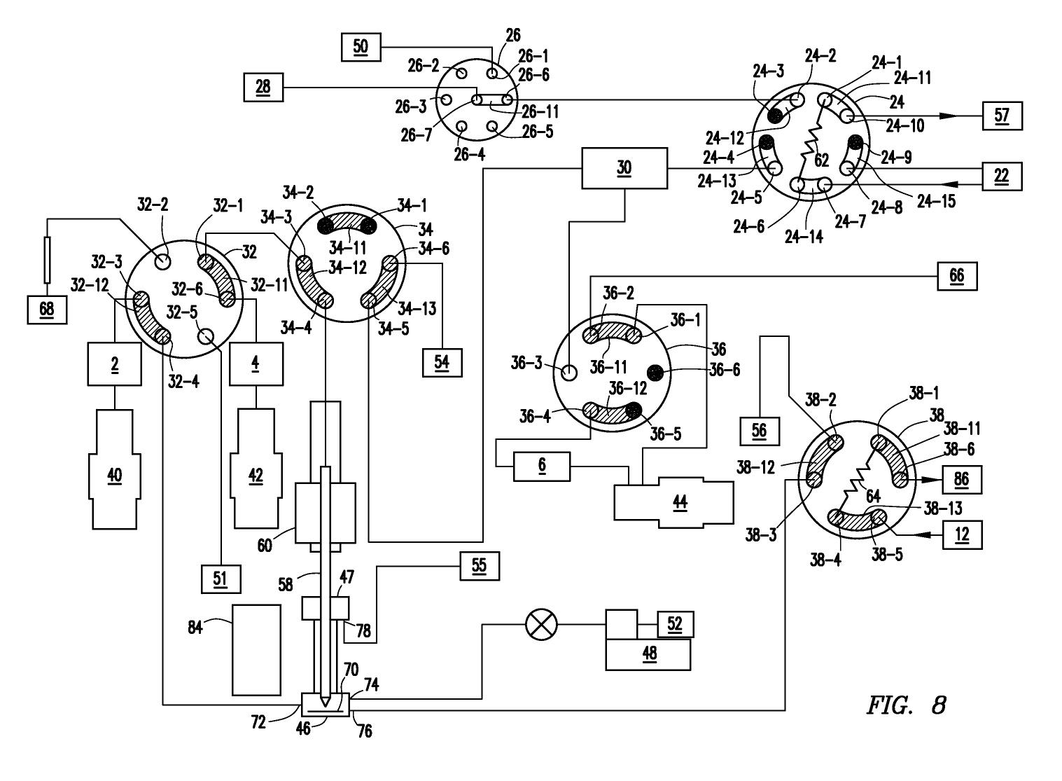

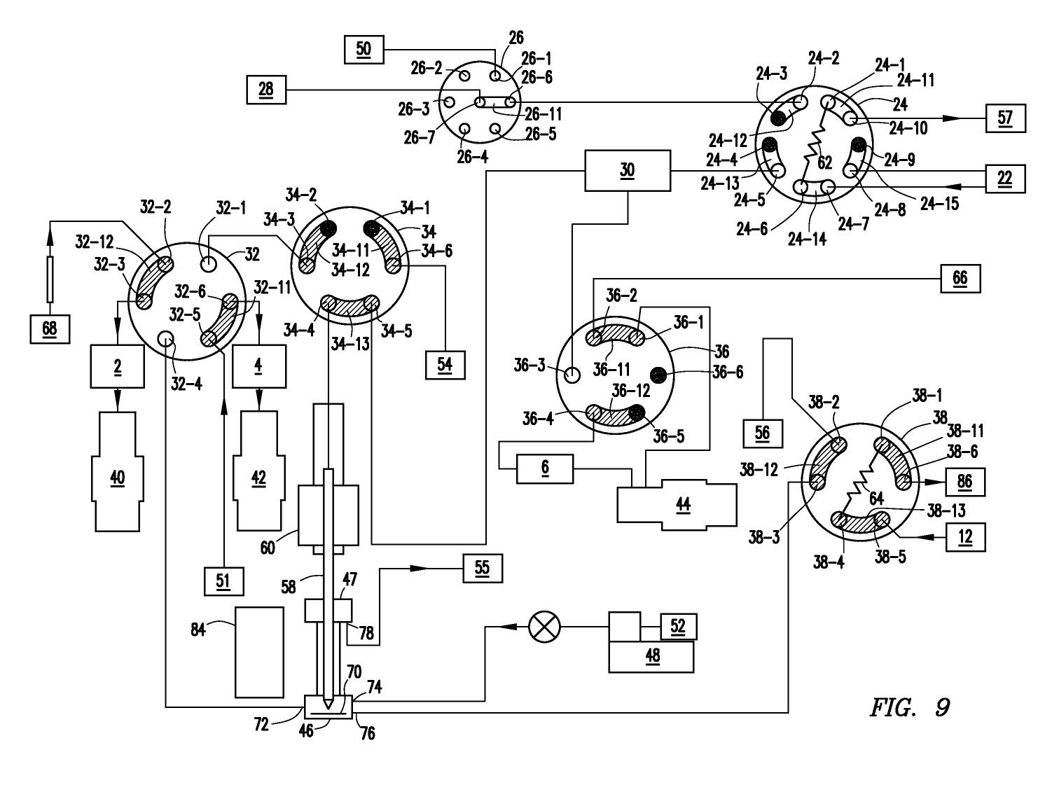

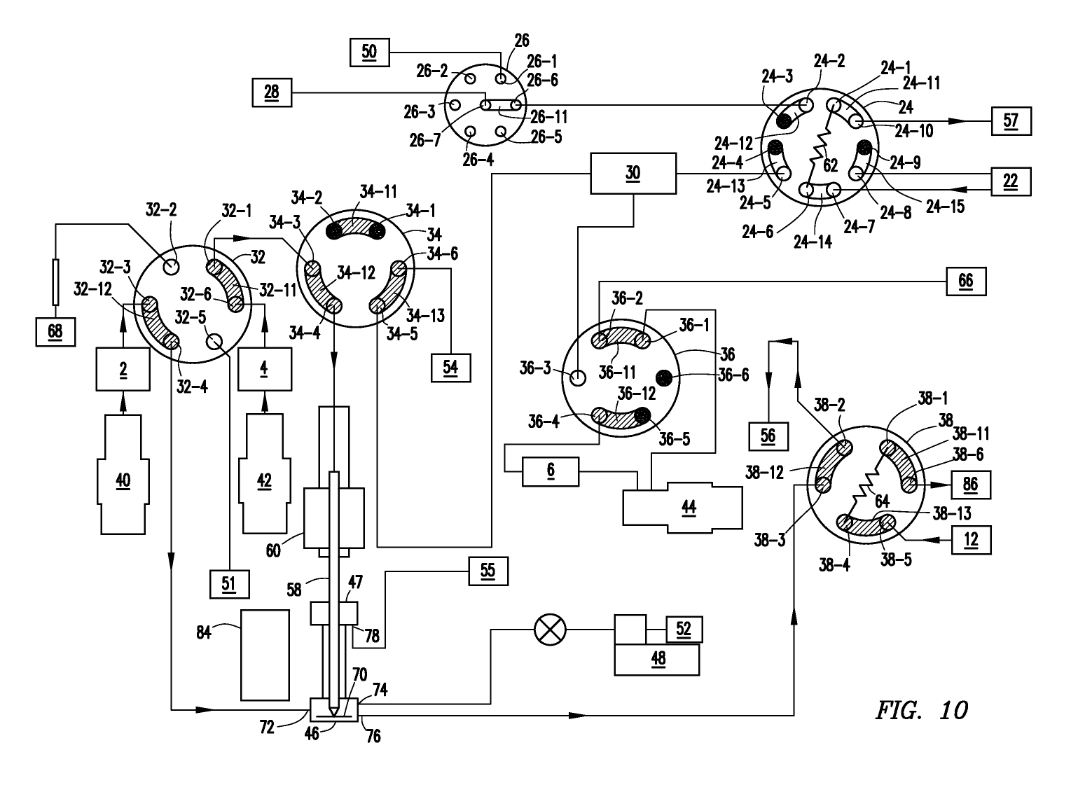

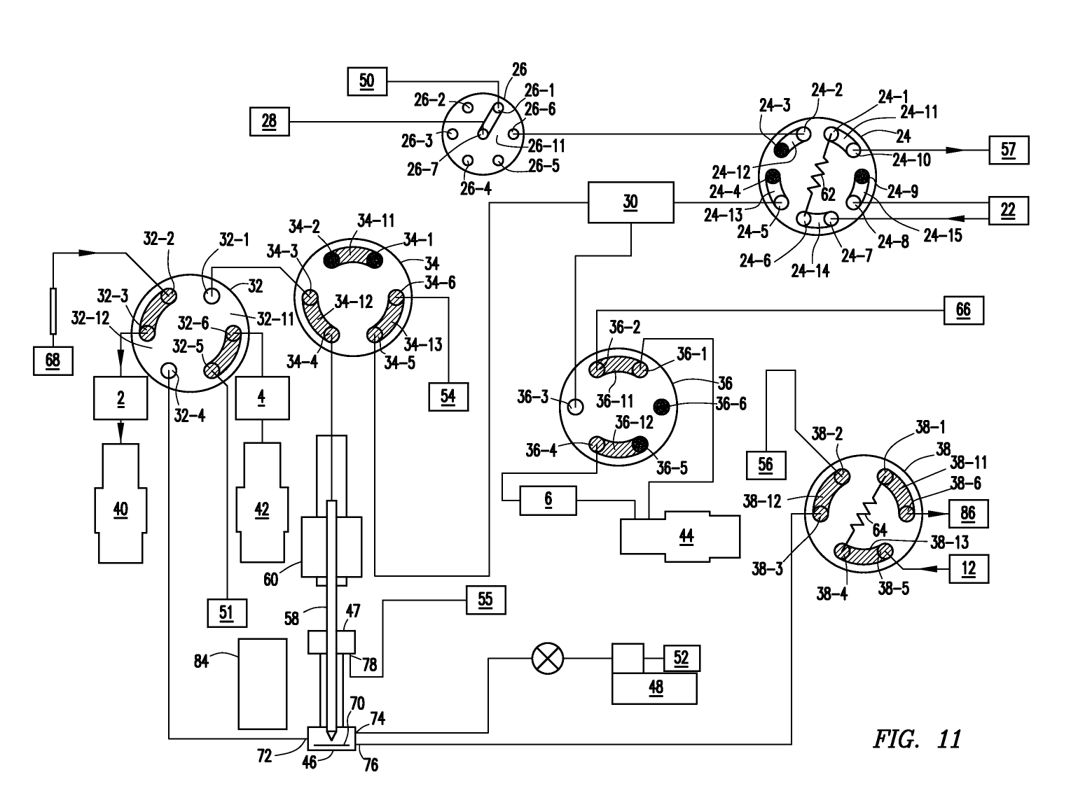

As shown in the exemplary embodiments of the figures and described in more detail below, the process sample and dilution system 20 is first calibrated by drawing a calibration solution (also referred to herein as “a calibration standard”) from a vial 84 (FIG. 2). External pump 28 and process pump 44 are then turned on and charged (FIG. 3). At this point, the external pump 28 draws (or pulls) wash from the first wash reservoir 50 through the fluidic port 26-1, flow-through conduit 26-11 and fluidic port 26-7 of the external process valve 26 while the process pump 44 draws diluent from the first diluent source 66 through the fluidic port 36-2, fluidic conduit 36-11 and fluidic port 36-1 of the process valve 36. At the same time, sample is drawn through fluidic ports 24-7, 24-6, 24-1 and 24-10, flow-through conduits 24-14 and 24-11 and the first sample loop 62 of the external sampling valve 24 to the fourth waste reservoir 57. The external pump 28 then discharges wash from the external process valve 26 through the external sampling valve 24 to backwash sample and sends sample to the mixing tee 30 (FIG. 4). At the mixing tee 30, sample is mixed with diluent. Diluted sample flows out of the mixing tee 30 to the online sampling valve 34 and, optionally, out to the first waste reservoir 54. Sample is then loaded into the injection needle 58 of the PSM 14 (FIG. 5). If required, the sample is further diluted at the fluidic tee 46 at which point the external pump 28 and the process pump 44 are turned off and the diluent pump 40 and the sample pump 42 are on (FIG. 6). Sample is then sent to the injection valve 38, loaded and injected into a solvent composition stream pumped from the solvent delivery system 12 (FIG. 7). The sample in the solvent composition stream flows to the column 86 (FIG. 8). Subsequently, the process sample and dilution system 20 undergoes a wash fill where diluent pump 40 and sample pump 42 are recharged (FIG. 9). Wash is emptied from the process sample manager 14 (FIG. 10). The diluent pump 40 is refilled and ready for the next injection (FIG. 11).

There are many advantages of the methods and systems disclosed herein. First, while sample volume must be large enough to move from the reactor 22 to the PSM 14, sample flow in the reactor 22 is largely undisturbed and not affected by the process sample and dilution system 20. Second, if the sample can be diluted, a larger sample volume is created and can be moved farther before unacceptable levels of diffusion are reached. For example, although the ends of a sample band undergo diffusion, the middle portion of the sample band away from the ends will remain unaffected. Diluted sample has a larger volume of sample away from the ends that is unaffected by diffusion in comparison to an undiluted sample. Diluted sample can therefore be moved farther than an undiluted sample. Also, the tubing throughout the system is dimensioned to minimize sample diffusion. For example, the diameter of the tubing can be small, e.g., as small as approximately about 100 μm. Diffusion is a concentration-driven mass transfer process that can be defined as the mass transferred per unit area per unit time. Small diameter tubing provides a corresponding small area over which diffusion can occur, thereby reducing diffusion.

FIG. 2 depicts the process sample and dilution system 20 configured for calibration. As described above, to calibrate the process sample and dilution system 20, calibration solution (a standard) is drawn from the vial 84. Here, the sample pump 42 is turned on to draw solution through the online sampling valve 34 and the priming valve 32. The priming valve 32 is configured so that flow-through conduit 32-11 provides a fluidic pathway between fluidic ports 32-1 and 32-6 and flow-through conduit 32-12 provides a fluidic pathway between fluidic ports 32-3 and 32-4. The sample pump 42 is turned on so to draw from the vial 84 as shown by the arrows between the sample pump 42 and the priming valve 32, and the online sampling valve 34 and the needle drive 60. The diluent pump 40 is off as well as the process pump 44 and the external pump 28. Standards or at-line samples are drawn into the injection needle 58. This calibration run allows the user to know that the system responds to a known standard/calibrant (same as the process sample or similar). The standard can be injected or diluted depending on the user's need. The fluidics of the PSM 14 treats the dilution of a standard, at-line sample the same way as an on-line injection. For that reason, the calibration run can predict exactly the response of an at-line or on-line sample. Standard/calibrant is the same as the process sample or at least similar in chemical constitution and response. During calibration, the injection needle 58 moves out of the vial 84 and into the fluidic tee 46.

Once the process sample and dilution system 20 is calibrated, as shown in FIG. 3 and noted above, the process pump 44 and the external pump 28 are both turned on and charged. The configurations of the external valve 26 and the priming valve 32 are changed. Process pump 44 draws diluent from the first diluent source 66 and the external pump 28 draws wash from the first wash reservoir 50. Specifically, the process pump 44 draws diluent from the first diluent source 66 into the process valve 36 at fluidic port 36-2 into flow-through conduit 36-11 and out fluidic port 36-1, providing a fluidic pathway between the first diluent source 66 and the process pump 44. Likewise, the external pump 28 draws wash from the first wash reservoir 50 through the external process valve 26 at fluidic port 26-1 into flow-through conduit 26-11 and out fluidic port 26-7. In addition, a fluidic pathway of sample between the reactor 22 and the fourth waste reservoir 57 where sample flows out of the reactor 22 into fluidic port 24-7 through flow-through conduit 24-14 and out fluidic port 24-6 through sampling loop 26 into fluidic port 24-1 through flow-through conduit 24-11 and out fluidic port 24-10 into the fourth waste reservoir 57. Sample constantly flows through the first sample loop 62 in this manner. While sample will not return to the reactor for most processes, recycle systems and devices can be connected to the fourth waste reservoir 57 or directly to the external sampling valve 24 to allow for the sample to flow back to the reactor, with or without further treatment or processing of the sample.

FIG. 4 depicts the process sample and dilution system 20 configured to move diluted process to the online sampling valve 34. Here, the configuration of the external process valve 26 changes. The external pump 28 discharges wash from the external process valve 26 into the external sampling valve 24 moving it to the mixing tee 30. Specifically, the external process valve 26 is rotated clockwise by one port position such that flow-through conduit 26-11 connects fluidic port 26-7 to fluidic port 26-6. Likewise, the configuration of the external sampling valve 24 is changed. The external sampling valve 24 is rotated counterclockwise by one port position such flow-through conduit 24-11 connects fluidic port 24-2 to fluidic port 24-1. The external pump 28 is connected to the external sampling valve 24, providing a backwash for sample to flow from the external sampling valve 24 to the mixing tee 30 and out to the online sampling valve 34 to a first waste reservoir 54 (if needed). If sample remains too long in the mixing tee 30, sample may get diffused. So, while it is not necessary, as a matter of timing, it is preferred that sample be diluted as soon as possible. Moreover, by diluting sample as it is moved through the mixing tee 30, a larger volume is created and the sample can be moved greater distances. The pressure drop across a tube can be calculated with the following formula:

Δp=8*ρ*(V²)/(π²*D⁴)*λ*L/D*0.00014504, where
ρ=solvent density (kg/m³)
V=flow velocity (m³/s)
D=tube diameter (m)
λ=Coefficient of friction
L=length of tube
0.00014504=Pa to psi

Further, transducers 2, 4, and 6 can monitor the diluent pump 40, the sample pump 42 and the process pump 44, respectively, and also diluent flow and sample flow into and out of the priming valve 32, the online sampling valve 34 and the process valve 36. The transducers 2, 4, and 6 of the process sample manager 4 use a strain gauge to translate the pressure into an electrical signal. Pressure or vacuum (sometimes referred to as negative pressure) can then be read. The signal provided by the pressure transducers 2, 4, and 6 in the process sample manager 14 allows for monitoring, sampling and drawing of diluent for blockages (i.e. high vacuum) and the dilution/quenching and injection for blockages (high pressure). Either of these faults would cause the process sample manager 14 to stop since they would compromise the performance of the process sample manager 14. A high pressure could mean that the liquid discharged or pushed is not delivered where it is meant to go or that the flow rate is too high. A high vacuum could indicate that the sample is too viscous for the flow rates used during the draw of the sample or diluent.

FIG. 5 shows the process sample and dilution system 20 having the valves configured to move the drawn sample into the injection needle 58. To fill the injection needle 58 with sample, the configurations of the priming valve 32, the process valve 36, the injection valve 38, the external sampling valve 24 and the external process valve 26 do not change and remain as shown in FIG. 4. Similarly, the external pump 28 is on and continues to discharge sample from the external sampling valve 24. The process pump 44 is on and continues to discharge diluent to the mixing tee 30, respectively.

However, as shown in FIG. 5, the online sampling valve 34 is turned clockwise by one port position (alternatively, a counterclockwise rotation achieves an equivalent configuration) such that flow-through conduit 34-12 or flow-through conduit 34-13 connects the fluidic port 34-4 to the fluidic port 34-5, and thereby connects the mixing tee 30 to the injection needle 58 to fill the injection needle 58 with sample as shown by the arrows. Because both fluidic ports 34-1 and 34-2 are plugged, there are no pathways for fluidic flow through the online sampling valve 34 via fluidic port 34-11 or fluidic port 34-12. As shown in FIG. 9, the injection needle 58 can lift off the seat 70 if sample is bubbling up within the fluidic tee 46. A wash pump 48 can draw wash from a third wash reservoir 52 connected to the fluidic tee 46 to wash the injection needle 58. The wash flows into a second waste reservoir 55 also connected to the fluidic tee 46.

FIG. 6 shows the process sample and dilution system 20 configured to dilute sample in the process sample manager 14. This is referred to sometimes as a second stage dilution. The configurations of the external process valve 26 and the injection valve 38 are unchanged from the drawing sample configuration shown in FIG. 5. Optionally, the external sampling valve 24 can remain in the same configuration as shown in FIG. 5; yet, optimally the external sampling valve 24 can change to the configuration as shown in FIG. 6 and described immediately below. Likewise, the configuration of process valve 36 as an option changes to the configuration shown in FIG. 5 or remains in the optimal configuration as shown in FIG. 6. Notwithstanding, the configurations of the priming valve 32 and the online sampling valve 34 are changed for a second stage dilution.

As shown in FIG. 6, the process valve 36 is turned counter-clockwise by one port position such that flow-through port conduit 36-12 connects fluidic port 36-4 to 36-5 and flow-through conduit 36-11 connects fluidic port 36-1 to 36-2. Fluidic port 36-5 and fluidic port 36-6 are plugged. As such, diluent from the first diluent source 66 does not flow through or out of the process valve 36. On the other hand, the priming valve 32 is rotated counterclockwise one port to provide diluent flow from the second diluent source 68. Flow-through conduit 32-12 connects fluidic ports 32-3 and 32-4 to provide a fluidic diluent pathway to the fluidic tee 46. This is depicted on FIG. 6 via arrows pointing out of the diluent pump 40 into the priming valve 32 and out to the fluidic tee 46. Similarly, flow-through conduit 32-11 connects fluidic port 32-1 and fluidic port 32-6 to provide a fluidic pathway from the sample pump 42 to the online sampling valve 34. The sample pump 42 discharges wash from the priming valve 32 through fluidic port 32-6 to fluidic port 32-1 via flow-through conduit 32-11 as shown by the arrows.

Further, as shown in FIG. 6, the online sampling valve 34 is rotated by one port position either counterclockwise as shown in FIG. 6 or clockwise (not shown). Flow-through conduit 34-12 connects the fluidic port 34-3 to the fluidic port 34-4 and together with the flow-through conduit 32-11 of the priming valve 32 provides a continuous fluidic pathway between the sample pump 42 and the injection needle 58. The needle drive 60 positions the injection needle 58 in the seat 70 of fluidic tee 46 and the sample pump 42 discharges the previously drawn wash through flow-through conduits 32-11 and 34-12 into the injection needle 58 as illustrated by arrows.

Essentially, wash displaces sample causing the sample within the injection needle 58 to enter the fluidic tee 46, as illustrated by arrows. The fluidic tee 46 operates to merge and mix sample with diluent entering the fluidic tee 46 at the first inlet 72, sample entering the fluidic tee 46. The diluted sample leaves the fluidic tee 46 through the first outlet 76 and travels to the fluidic port 38-3 of the injection valve 38, as illustrated by arrows between the same. Any overfill of sample passes to a third waste reservoir 56 from the fluidic port 38-3 through flow-through conduit 38-12 and out through the fluidic port 38-2.

To dilute the sample, the diluent pump 40 and the sample pump 42 move fluids concurrently. The flow rates of these pumps determine the dilution ratio (overall dilution flow rate to process sample flow rate). Consider, for example, an overall dilution flow rate of 100 μl/min, with the sample pump 42 discharges 10 μl/min while the diluent pump 40 discharges 90 μl/min: the result is a 10:1 dilution. When, for example, the sample pump 42 discharges 50 μ1/min, while the diluent pump 40 discharges 50 μl/min, the result is a 2:1 dilution. If a second stage dilution (a dilution of sample in the PSM 14) is not desired, sampling steps remain the same as described herein, but the dilution pump 40 does not provide any flow and the sample pump 42 provides the flow to move the sample from the needle 48 to the injection loop 64.

FIG. 7 shows the process sampling and dilution system 20 having valves configured to load sample into second sample loop 64 of the injection valve 38. The configurations of the priming valve 32, the online sampling valve 34, and the external process valve 26 are as shown in FIG. 6. Similarly, the configurations of the process valve 36 and the external sampling valve 24 remain in the optimal configurations of FIG. 6. However, the configuration of the injection valve 38 is changed. The injection valve 38 is rotated counter-clockwise by one port position. The sample pump 42 continues to operate and sample is discharged into the second sample loop 64, as illustrated by arrows between the fluidic tee 46 and the injection valve 38. The diluent pump 40 and the process pump 44 are off.

More specifically, flow-through conduit 38-12 connects fluidic port 38-3 to fluidic port 38-4 to provide a continuous fluidic pathway from the first outlet 76 of the fluidic tee 46 through the sample loop 64 into fluidic port 38-1 of flow-through conduit 38-11 out of fluidic port 38-2 to the third waste reservoir 56 and capturing any overfill of the second sample loop 65. In addition, flow-through conduct 38-13 connects fluidic port 38-5 to fluidic port 38-6 for a continuous flow of solvent composition stream from the solvent delivery system 12 to the column 86.

FIG. 8 shows the process sample and dilution system 20 having valves configured to inject the sample into the column 86 or a detector. Here, sample is mixed with the solvent composition stream arriving at the injection valve 38 from the solvent delivery system 12. The configuration of the priming valve 32, the online sampling valve 34, the process valve 36, the external sampling valve 24, and the external process valve 26 are unchanged from the configurations shown in FIG. 7. The configuration of the injection valve 38, however, changes.

To introduce the diluted sample to the solvent composition stream, the injection valve 38 is rotated clockwise by one port position from its position shown in FIG. 7 (i.e., back to the position of FIG. 6) such that flow-through conduit 38-11 connects the fluidic port 38-1 to the fluidic port 38-6 and flow-through conduit 38-13 connects the fluidic port 38-5 to fluidic port 38-4. This configuration places the second sample loop 64, and the sample contained therein, in the path of the solvent composition stream arriving from the solvent delivery system 12. In this manner, the diluted process sample is introduced to the solvent composition stream.

FIG. 9 shows the process sample and dilution system 20 having the valves configured to wash fill. The configurations of the process valve 36, the injection valve 38, the external sampling valve 24, and the external process valve 26 are unchanged from the configuration shown in FIG. 8. However, the configuration of the priming valve 32 and the online sampling valve 34 are changed. The priming valve 32 is rotated one port position such that flow-through conduit 32-11 connects fluidic port 32-5 to fluidic port 32-6, thereby fluidically connecting the second wash reservoir 51 to the sample pump 42. Also, fluidic conduit 32-12 connects fluidic port 32-2 to fluidic port 32-3, thereby connecting the second diluent source 68 with the diluent pump 40. The online sampling valve 34 is rotated one port position such that flow-through conduit 34-13 connects fluidic port 34-4 to fluidic port 34-5. Flow-through conduct 34-12 connects fluidic port 34-6 to plugged fluidic port 34-1, and flow-through conduit 34-11 connects plugged fluidic port 34-2 to fluidic port 34-3. The diluent pump 40 can draw diluent into the priming valve 32 as shown by the arrow between the second diluent source 68 and the priming valve 32, and the arrow between priming valve 32 and the dilute pump 40. The sample pump 42 is turned on to draw wash from the second wash reservoir 51. The wash pump 48 is also turned on to draw wash from the third wash reservoir 52 to the wash tower 47 out of the second outlet 78 to the second waste reservoir 55.

FIG. 10 shows the process sample and dilution system 20 having the valves configured to empty wash from the pumps and generally clean out the tubing. The configurations of the process valve 36, the injection valve 38, the external sampling valve 24, and the external valve 26 are unchanged from the configuration to run a wash fill as set out in FIG. 9. However, the configurations of the online sampling valve 34 and the priming valve 32 are changed. Here, the online sampling valve 34 is rotated one port position such that fluidic conduit 34-11 connects plugged fluidic port 34-1 to plugged fluidic port 34-2. Flow-through conduit 34-12 connects fluidic port 34-3 to fluidic port 34-4, and flow-through conduit 34-13 connects 34-5 to 34-6, providing a continuous fluidic pathway from the priming valve 32 through the injection needle 58 to the seat 70 of the fluidic tee 46 as shown by the arrows.

Likewise, the priming valve 32 is rotated one port position such that flow-through conduit 32-11 connects fluidic port 32-1 to fluidic port 32-6 and flow-through conduit 32-12 connects plugged fluidic port 32-3 to fluidic port 32-4 providing a continuous fluidic pathway from sample pump 42 through the priming valve 32 to the online sampling valve 34 as shown by the arrows. During this phase, the diluent pump 40 and sample pump 42 are both pumping. As a result, both the diluent pump 40 and the sample pump 42 are connected to the fluidic tee 46 and the injection valve 38 where sample is washed through to the third waste reservoir 56. Noteworthy is the fact that it takes 3 to 5 times the pump volume to wash a pump out. However with the systems and methods disclosed herein, sample is not sent to the pump. Therefore, external pump 28, diluent pump 40 or process pump 44 does not contain sample and therefore less sample volume is required. So, it is not necessary to wash out the pump.

FIG. 11 shows the process sample and dilution system 20 having valves configured to refill diluent pump 40 and get ready for the next injection. The configurations of the online sampling valve 34, the process valve 36, the injection valve 38, and the external sampling valve 24 are unchanged from the empty wash configuration of FIG. 10. However, the priming valve 32 is changed and is rotated one port position. Optionally, the configuration of the external process valve 26 is changed. At this point, optimally, the external valve 26 is configured to allow the external pump 28 to pull in wash from a first wash reservoir 50 through fluidic port 26-1 into flow-through conduit 26-11 and out fluidic port 26-7. As shown in FIG. 11, the priming valve 32 is also configured so that the diluent pump 40 is ready to draw diluent from the second diluent source 68. Here, flow-through conduit 32-12 connects fluidic port 32-2 to fluidic port 32-3 and flow-through conduit 32-11 connects fluidic port 32-6 to fluidic port 32-5.

One of ordinary skill in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

We claim:

1. A process sample and dilution system configured to be in fluidic communication with a chromatographic column or detector comprising:
a process sample manager comprising an online sampling valve, the process sample manager connected to the chromatographic column or detector; and
an external pump valve assembly connected to the process sample manager, the external pump valve assembly comprising:
(i) an external sampling valve connected to a reactor or a reactor flow stream and configured to draw sample from the reactor or the reactor flow stream;
(ii) an external process valve connected to an external pump and the external sampling valve; and
(iii) a mixing tee connected to the external sampling valve and the online sampling valve of the process sample manager.

2. The process sample and dilution system of claim 1, further comprising a wash source, wherein the wash source is configured to be in fluidic communication with the external pump and the external sampling valve.

3. The process sample and dilution system of claim 2, wherein the external pump is configured to draw wash from a wash source into the external process valve and to discharge drawn wash from the external process valve to the external sampling valve.

4. The process sample and dilution system of claim 1, wherein the process sample manager further comprises a process valve connected to a first diluent source and a process pump configured to be in fluidic communication with the mixing tee.

5. The process sample and dilution system of claim 4, wherein the process pump is configured to draw diluent from the first diluent source and discharge diluent to the mixing tee.

6. The process sample and dilution system of claim 1, the process sample manager further comprising an injection needle and a fluidic tee, wherein the injection needle is connected to the online sampling valve, and the fluidic tee is configured to be in fluidic communication with the online sampling valve and a second diluent source.

7. The process sample and dilution system of claim 1, wherein the process sample manager further comprises an injection valve configured to be in fluidic communication with the column or the detector and connected to the fluidic tee.

8. The process sample and dilution system of claim 1, wherein the external pump valve assembly is in a spaced relationship to the process sample manager.

9. An external pump valve assembly configured to be in fluidic communication with a solvent delivery system comprising:
an external sampling valve connected to a reactor or a reactor flow stream and configured to draw sample from the reactor or the reactor flow stream;
an external process valve connected to the external sampling valve;
an external pump; and
a mixing tee connected to the external sampling valve and the process sample manager.

10. The external pump valve assembly of claim 9 further comprising a wash source, wherein the wash source is in fluidic communication with the external pump.

11. The external pump valve assembly of claim 10, wherein the external pump is a positive displacement pump configured to draw wash from the wash source and discharge wash to the external sampling valve.

12. The external pump valve assembly of claim 9, wherein the external sampling valve is configured to acquire a discrete or continuous sample from a reactor or a reactor flow stream.

13. The external pump valve assembly of claim 9, wherein the mixing tee is configured to be in fluidic communication with a first source of diluent.

14. The external pump valve assembly of claim 9, wherein the external pump valve assembly is connected to a process sample manager and the process sample manager is configured to be in fluidic communication with the reactor or reactor flow stream and the solvent delivery system.

15. A liquid chromatography system having a column comprising:
an external pump valve assembly comprising an external sampling valve, an external pump and a mixing tee, wherein the external sampling valve is connected to a reactor or a reactor flow stream and configured to draw sample from the reactor or the reactor flow stream, the external process valve is connected to the external sampling valve and the external pump and the mixing tee is connected to the external sampling valve;
a process sample manager in fluidic communication with the external pump valve assembly; and
a solvent delivery system in fluidic communication with the process sample manager.

16. The liquid chromatography system of claim 15, further comprising a wash source, wherein the wash source is configured to be in fluidic communication with the external pump and the external sampling valve.

17. The liquid chromatography system of claim 16, wherein the external pump is configured to draw wash from a wash source into the external process valve and to discharge drawn wash from the external process valve to the external sampling valve.

18. The liquid chromatography system of claim 15, wherein the process sample manager further comprises a process valve connected to a first diluent source and a process pump, wherein the process pump is configured to be in fluidic communication with the first diluent source and the mixing tee.

19. The liquid chromatography system of claim 18, wherein the process pump is configured to draw diluent from the first diluent source and discharge diluent to the mixing tee.

20. A method of sampling and diluting of a sample from a reactor or reactor stream for liquid chromatography detection comprising:
acquiring a discrete or continuous sample from a reactor or a reactor flow stream with an external pump valve assembly in fluidic communication with the reactor or the reactor flow stream wherein the external pump valve assembly comprises an external pump, an external sampling valve, and a mixing tee, and each of the external pump, the external sampling valve and the mixing tee are configured to be in fluidic communication with the other;
one or both of quenching and diluting the sample in the mixing tee;
discharging the sample to a process sample manager configured to be in fluidic communication with the external pump valve assembly, wherein the process sample manager is in a spaced relationship with the external pump valve assembly; and
injecting the sample into a solvent composition stream received by a detector.
